(19) United States
(12) Patent Application Publication
(10) Pub. No.: US 2025/0291770 A1
(43) Pub. Date: Sep. 18, 2025

(54) Seamless NFS Server Pod Addition

(71) Applicant: Rakuten Symphony, Inc., Tokyo (JP)

(72) Inventor: Jagadish Mukku, Sunnyvale, CA (US)

(21) Appl. No.: 18/006,965

(22) PCT Filed: Dec. 12, 2022
(86) PCT No.: PCT/US2022/052581

§ 371 Date: Jan. 26, 2023

(51) Int. Cl. G06F 16/182

(52) U.S. Cl. CPC G06F 16/183; G06F 16/1827

(57) ABSTRACT

A cluster may include one or more NFS server pods having multiple storage volumes mounted thereto. Due to loading or other need, a new NFS server pod may be instantiated to handle traffic to one or more of the multiple storage volumes. The new NFS server pod is instantiated and an agent of an orchestrator instantiates a container for an NFS server and configures the new NFS server pod to communicate with clients of the NFS server, which may include configuring a source address of the new NFS server pod and configuring an NFS service of the cluster with an association between the source address and the one or more storage volumes of the new NFS server pod.

### BACKGROUND

### Field of the Invention

This invention relates to the seamless addition of server pods.

### Background of the Invention

Whether processing ecommerce transactions, streaming content, providing back-end data management for mobile applications, or other services, the modern company requires a large amount of computing resources including processor time, memory, and persistent data storage. The amount of computing resources varies over time. Modern computing installations can dynamically sale up and scale down in order to adapt to changes in usage. For example, Kubernetes is a popular tool for adding and removing instances of applications based on usage. The high variability in usage of computing resources makes it difficult to manage on-premise computing hardware and purchased cloud computing resources.

It would be an advancement in the art to enable better adaptation to variation in usage of computing resources.

### SUMMARY OF THE INVENTION

An apparatus includes a computing device including a plurality of processing devices and one or more memory devices operably coupled to the plurality of processing devices. The one or more memory devices storing executable code that, when executed by the plurality of processing devices, causes the plurality of processing devices to execute a cluster including a first pod implementing a first remote file system server, the first pod having a plurality of storage volumes mounted thereto. A remote file system service executes in the cluster for enabling access to the first remote file system server. A plurality of application instances execute in the cluster and are configured to access the plurality of storage volumes using the first remote file system server using the remote file system service. A second pod is instantiated in the cluster and implements a second remote file system server. At least one storage volume of the plurality of storage volumes is mounted to the second remote file system server. The remote file system service is configured to enable access to the at least one storage volume using the second remote file system server.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a network environment in which NFS server pods may be deployed in accordance with an embodiment;

FIG. 2 is a schematic block diagram showing components for adding an NFS server pod in accordance with an embodiment;

FIG. 3 is a schematic block diagram showing components for configuring a new server pod and NFS service in accordance with an embodiment;

FIG. 4 is a process flow diagram of a method for instantiating and configuring a new NFS server pod in accordance with an embodiment; and

FIG. 5 is a schematic block diagram of an example computing device suitable for implementing methods in accordance with embodiments of the invention.

### DETAILED DESCRIPTION

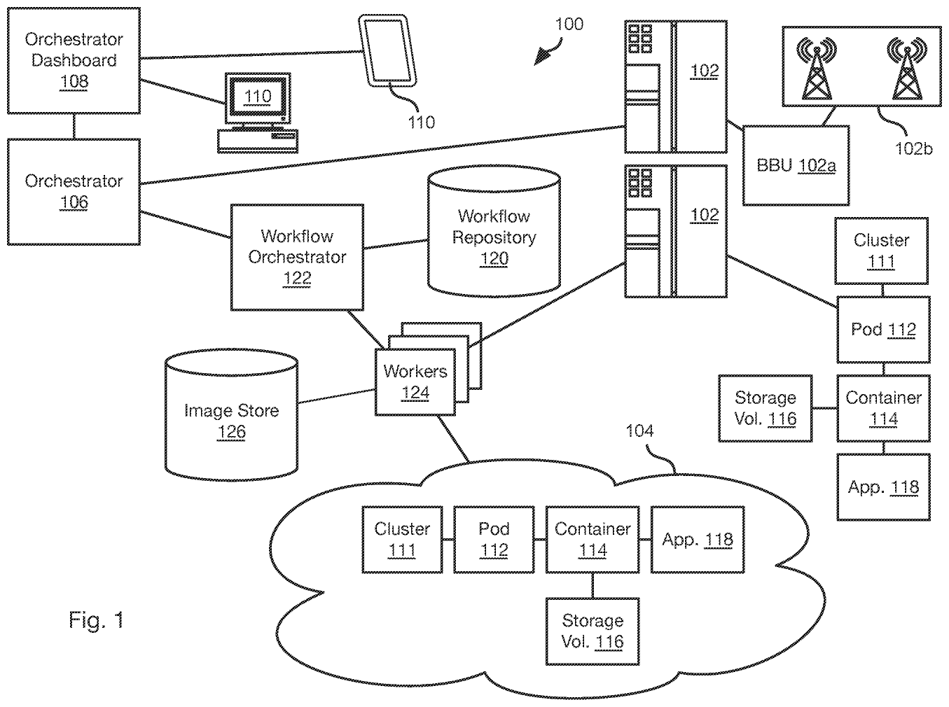

FIG. 1 illustrates an example network environment 100 in which the systems and methods disclosed herein may be used. The components of the network environment 100 may be connected to one another by a network such as a local area network (LAN), wide area network (WAN), the Internet, a backplane of a chassis, or other type of network. The components of the network environment 100 may be connected by wired or wireless network connections.

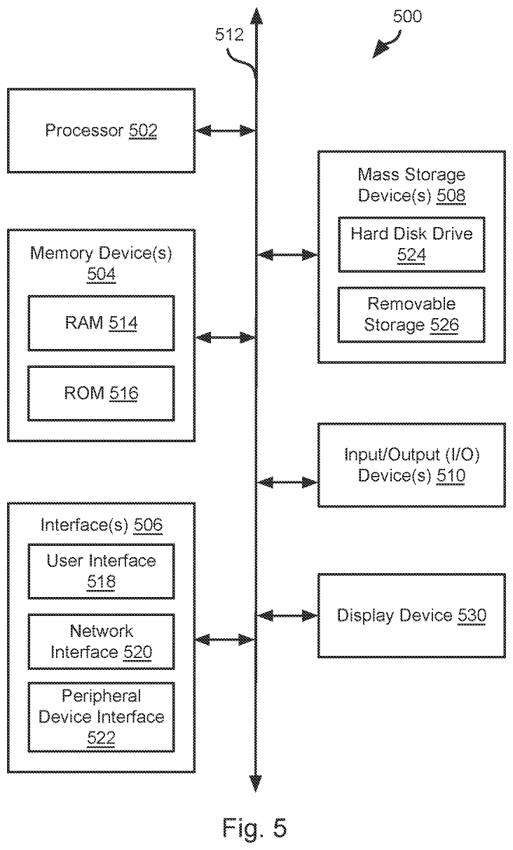

The network environment 100 includes a plurality of servers 102. Each of the servers 102 may include one or more computing devices, such as a computing device having some or all of the attributes of the computing device 500 of FIG. 5.

Computing resources may also be allocated within a cloud computing platform 104, such as amazon web services (AWS), GOOGLE CLOUD, AZURE, or other cloud computing platform. Cloud computing resources may include purchased physical storage, processor time, memory, and/or networking bandwidth in units designated by the provider by the cloud computing platform.

In some embodiments, some or all of the servers 102 may function as edge servers in a telecommunication network. For example, some or all of the servers 102 may be coupled to baseband units (BBU) 102a that provide translation between radio frequency signals output and received by antennas 102b and digital data transmitted and received by the servers 102. For example, each BBU 102a may perform this translation according to a cellular wireless data protocol (e.g., 4G, 5G, etc.).

An orchestrator 106 provisions computing resources to application instances of one or more different application executables, such as according to a manifest that defines requirements of computing resources for each application instance. The manifest may define dynamic requirements defining the scaling up of a number of application instances and corresponding computing resources in response to usage. The orchestrator 106 may include or cooperate with a utility such as KUBERNETES to perform dynamic scaling up and scaling down the number of application instances.

An orchestrator 106 may execute on a computer system that is distinct from the servers 102 and may be connected to the servers 102 by a network that requires the use of a destination address for communication, such as using a networking including ethernet protocol, internet protocol (IP), Fibre Channel, or other protocol, including any higher-level protocols built on the previously-mentioned protocols, such as user datagram protocol (UDP), transport control protocol (TCP), or the like.

The orchestrator 106 may cooperate with the servers 102 to initialize and configure the servers 102. For example, each server 102 may cooperate with the orchestrator 106 to obtain a gateway address to use for outbound communication and a source address assigned to the server 102 for use in inbound communication. The server 102 may cooperate with the orchestrator 106 to install an operating system on the server 102. For example, the gateway address and source address may be provided and the operating system installed using the approach described in U.S. application Ser. No. 16/903,266, filed Jun. 16, 2020 and entitled AUTOMATED INITIALIZATION OF SERVERS, which is hereby incorporated herein by reference in its entirety.

The orchestrator 106 may be accessible by way of an orchestrator dashboard 108. The orchestrator dashboard 108 may be implemented as a web server or other server-side application that is accessible by way of a browser or client application executing on a user computing device 110, such as a desktop computer, laptop computer, mobile phone, tablet computer, or other computing device.

The orchestrator 106 may cooperate with the servers 102 in order to provision computing resources of the servers 102 and instantiate components of a distributed computing system on the servers 102 and/or on the cloud computing platform 104. For example, the orchestrator 106 may ingest a manifest defining the provisioning of computing resources to and the instantiation of components such as a cluster 111, pod 112 (e.g., KUBERNETES pod), storage volume 116, and an application instance 118. The orchestrator 106 may then allocate computing resources and instantiate the components according to the manifest.

In conventional approaches, application instances 118 are hosted within containers 114, such as DOCKER containers. As used herein a “container” may be understood as software that packages all dependencies of an application image so that the application will execute reliably and quickly in any given computing environment. For example, a container may include executable code, runtime, system tools, system libraries, settings, and the like that enable the application image to execute on a host either with or without an underlying operating system. As used herein “host” may be understood to be a server 102 or unit of computing resources in the cloud computing platform 104.

The manifest may define requirements such as network latency requirements, affinity requirements (same node, same chassis, same rack, same data center, same cloud region, etc.), anti-affinity requirements (different node, different chassis, different rack, different data center, different cloud region, etc.), as well as minimum provisioning requirements (number of cores, amount of memory, etc.), performance or quality of service (QOS) requirements, or other constraints. The orchestrator 106 may therefore provision computing resources in order to satisfy or approximately satisfy the requirements of the manifest.

The instantiation of components and the management of the components may be implemented by means of workflows. A workflow is a series of tasks, executables, configuration, parameters, and other computing functions that are predefined and stored in a workflow repository 120. A workflow may be defined to instantiate each type of component (cluster 111, pod 112, container 114, storage volume 116, application instance, etc.), monitor the performance of each type of component, repair each type of component, upgrade each type of component, replace each type of component, copy (snapshot, backup, etc.) and restore from a copy each type of component, and other tasks. Some or all of the tasks performed by a workflow may be implemented using KUBERNETES or other utility for performing some or all of the tasks.

The orchestrator 106 may instruct a workflow orchestrator 122 to perform a task with respect to a component. In response, the workflow orchestrator 122 retrieves the workflow from the workflow repository 120 corresponding to the task (e.g., the type of task (instantiate, monitor, upgrade, replace, copy, restore, etc.) and the type of component. The workflow orchestrator 122 then selects a worker 124 from a worker pool and instructs the worker 124 to implement the workflow with respect to a server 102 or the cloud computing platform 104. The instruction from the orchestrator 106 may specify a particular server 102, cloud region or cloud provider, or other location for performing the workflow. The worker 124, which may be a container, then implements the functions of the workflow with respect to the location instructed by the orchestrator 106. In some implementations, the worker 124 may also perform the tasks of retrieving a workflow from the workflow repository 120 as instructed by the workflow orchestrator 122.

In some implementations, the containers implementing the workers 124 are remote from the servers 102 with respect to which the workers 124 implement workflows. The workers 124 may further implement some or all workflows either with or without an agent installed on the server 102 or cloud computing platform 104 that is programmed to cooperate with the workers 124 to implement the workflow. For example, the workers 124 may establish a secure command line interface (CLI) connection to the server 102 or cloud computing platform 104. For example secure shell (ssh), remote login (rlogin), or remote procedure calls (RPC), or other interface provided by the operating system of the server 102 or cloud computing platform 104 may be used to transmit instructions and verify the completion of instructions on the server 102 or cloud computing platform 104. When instantiating a component on a host (i.e., a server 102 or a unit of computing resources on the cloud computing platform) according to a workflow, the workers 124 may retrieve an executable image for the component from an image store 126.

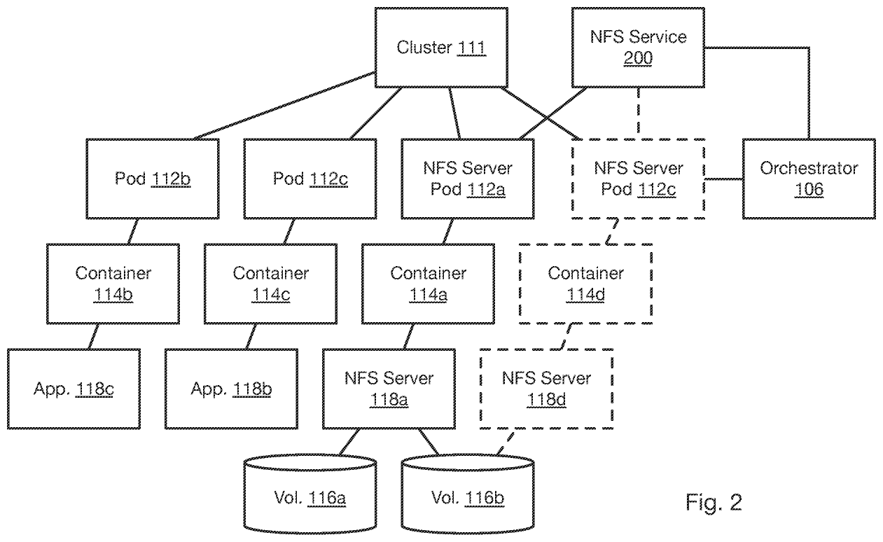

Referring to FIG. 2, network file system (NFS) is a distributed file system protocol that enables a process on a first computer to access storage on a remote server in the same manner as the process accesses storage local to the first computer. Although the examples described herein refer to NFS, other approaches for implementing remote file systems may be used in the same manner, such as server message block (SMB), common internet file system (CIFS), or the like. In a KUBERNETES installation, a pod 112a may function as a NFS server pod including one or more containers 114a each having one or more storage volumes 116a, 116b mounted thereto. In this and other example disclosed herein, each NFS server pod is shown with one container and one corresponding NFS server with the understanding that an NFS server pod may include any number of containers hosting any number of NFS servers providing remote access to any number of storage volumes. For example, the NFS server pod may be configured with a separate address for each NFS server or a common address used by all NFS servers of the NFS server pod.

The storage devices implementing the storage volumes 116a, 116b may be local to the computing device (e.g., server 102 or unit of computing resources in the cloud computing platform 104) executing the container 114a. The container 114a may execute an NFS server 118a enabling access to the one or more storage volumes 116a, 116b.

Application instances 118b, 118c executing in other containers 114b, 114c, respectively, and hosted by one or more other pods 112b may access the storage volumes 116a, 116b using the NFS server 118a. For example, application instance 118b may access storage volume 116a and application instance 118c may access storage volume 116b. The NFS server 118a may be mounted to the containers 114b, 114c and the application instances 118b, 118c may access the NFS server 118a in the same manner (e.g., same system calls to read, write, and navigate the file system) as a local storage volume.

The application instances 118b, 118c may discover the NFS server 118a and acquire sufficient information to access the NFS server 118a by means of an NFS service 200. The NFS service 200 may be embodied as a construct storing data describing the NFS server 118a and any other NFS servers executing in the cluster 111. For example, the cluster 111 may define an internal network used for communication among the components of the cluster 111. The NFS service 200 may be a construct within the software components implementing the internal network in order to route NFS traffic between clients and NFS servers. Accordingly, functionality ascribed herein to the NFS service 200 may be performed by software components implementing the internal network of the cluster 111.

In some embodiments, the NFS service 200 includes a mapping between an IP address (or some other type of address) of the pod 112a and/or container 114a to an identifier of the storage volume 116a, 116b accessible by NFS protocol using the NFS server 118a. The pods 112b and/or containers 114b, 114c may therefore access the NFS service 200 in order to obtain the IP address of the pod 112a and mount the storage volumes 116a, 116b as NFS storage volumes. The NFS service 200 may also act as a proxy: containers 114b, 114c may mount the NFS server 118a using an IP address assigned to the NFS service 200, which then acts as a proxy for communication between the NFS server 118a and the containers 114b, 114c to implement data exchange according to the NFS protocol.

In some instances, one application instance 118b may generate substantially more traffic than another application instance 118c or require a dedicated NFS server for security, performance, or some other reason. The orchestrator 106 may therefore invoke instantiation of another NFS server pod 112c hosting a container 114d executing a NFS server 118d. Mounting of one of the storage volumes 116b may be transferred to the container 114d. The NFS service 200 may further be updated to include the IP address of the new NFS server pod 112c and/or the container 114d. The process by which a new

NFS server pod 112c is instantiated and the storage volume 116b is transferred to the new NFS server pod 112c may be performed with very little disruption using the approach described hereinbelow.

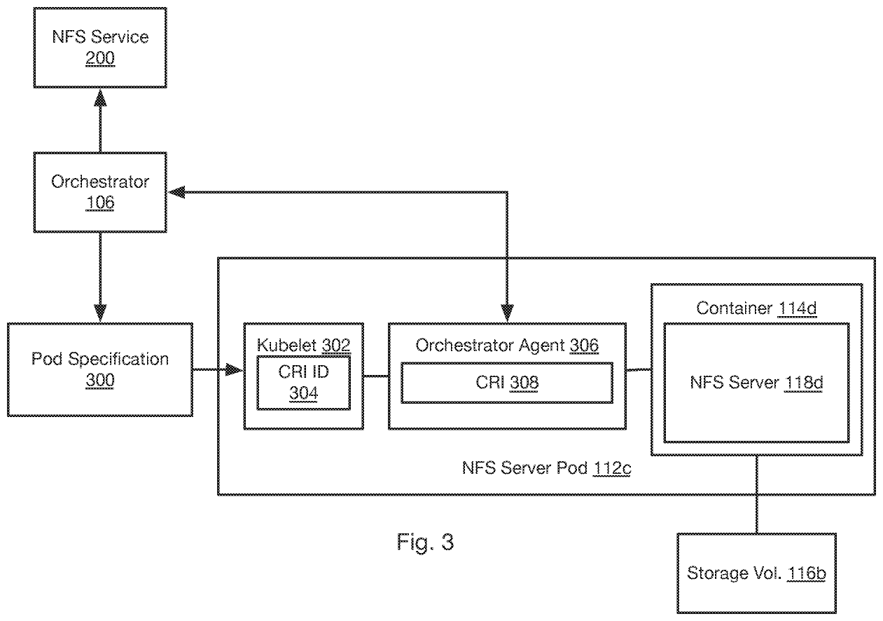

Referring to FIG. 3, the transfer of a storage volume 116b to a new NFS server pod 112c may be performed using the illustrated components. The orchestrator 106 may invoke instantiation of a new NFS server pod 112c according to a pod specification 300. Instantiation of the new NFS server pod 112c may also be invoked automatically based on usage, such as by a KUBERNETES master managing the cluster 111. The pod specification 300 may configure the NFS server pod 112c with a Kubelet 302 that functions as a virtual host managing the instantiation and operation of containers 114d of the NFS server pod 112c. The Kubelet 302 may be configured with an identifier 304 (e.g., pointer) of a container runtime interface (CRI) for containers managed by the Kubelet 302.

The Kubelet 302 will call the CRI in order to perform tasks relative to containers. In this manner, the Kubelet 302 does not need to have specialized code for each type of container managed by the Kubelet 302. The CRI identifier 304 may refer to an orchestrator agent 306 that is an agent of the orchestrator 106. The Kubelet 302 will therefore invoke the orchestrator agent 306 to perform container management tasks. For example, in addition to performing the specialized tasks ascribed herein to the orchestrator agent 306, the orchestrator agent 306 may include a container runtime interface 308 configured to perform tasks performed by conventional CRI such as instantiating containers, suspending containers, stopping containers, repairing containers, restarting containers, monitoring usage of containers, performing health checks of containers, or other container management tasks.

The Kubelet 302 may call the orchestrator agent 306 to create a container 114d including an application instance that is the NFS server 118d as specified in the pod specification 300 or a separate container specification received by the Kubelet 302 from the orchestrator 106 or some other source. In response, the orchestrator agent 306 instantiates the container 114d and NFS server 118d. Prior to starting execution of the container 114d and NFS server 118d, the orchestrator agent 306 may cooperate with the orchestrator 106 to configure the container 114d and/or NFS Server 118d. For example, the orchestrator agent 306 may configure the NFS server pod 112c and/or container 114d to use IP address as the source address for packets transmitted from the NFS server pod 112c and/or container 114d. The IP address may also used by other application instances 118b, 118c to address requests to the NFS server 118d. The orchestrator 106 may also configure the NFS service 200 to associate the IP address with the storage volume 116b and NFS server 118d. The orchestrator 106 may further broadcast availability of the storage volume 116b and the IP address or respond to requests for an identifier of the storage volume 116b with the IP address such that the requester (e.g., application instance 118b) can mount the storage volume 116b as an NFS volume in cooperation with the NFS server 118d.

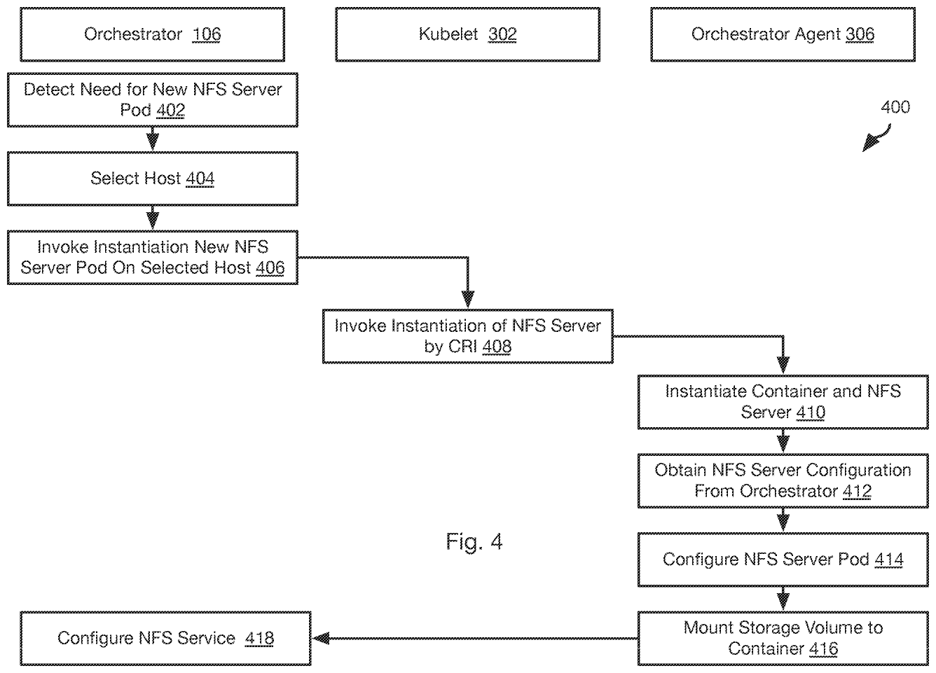

FIG. 4 illustrates a method 400 that may be performed in order to transition a storage volume 116b from a first NFS server pod 112a to a second NFS server pod 112b and transition an application instance 118b from accessing the storage volume 116b through the first NFS server pod 112a to accessing the storage volume 116b through the second NFS server pod 112b.

The method 400 may include detecting 402 a need for a new NFS server pod. Detecting a need for a new NFS server pod may be determined based on an application instance 118b experiencing latency on reads and/or writes to the storage volume 116b exceeding a maximum latency. The need for a new NFS server pod may be detected based on a total number of read and/or writes received by the NFS server pod 112a exceeding a threshold, an average response time of an existing NFS server pod 112a to read and/or write operations rising above a maximum response time, or some other criteria. Step 402 may also include receiving an instruction from an administrator to create a new NFS server pod.

In response to detecting 402 the need for a new NFS server pod, the orchestrator 106 selects 404 a host to execute the new NFS server pod. The host may be a server 102 or a unit of computing resources of the cloud computing platform 104. The host may be selected based on one or more criteria, such as latency with respect to one or more application instances 118b that will be accessing the new NFS server pod or latency with respect to a storage device storing the storage volume 116b (lower latency preferred).

The host may be selected based on an affinity requirement with respect to another component (the application instance 118b, the NFS server pod 112a that previously was used to access the storage volume 116b, or some other component). The host may be selected based on an anti-affinity requirement with respect to another component (the application instance 118b, the NFS server pod 112a that previously was used to access the storage volume 116b, or some other component). As used herein, an affinity requirement refers to a requirement that two components have a required degree of proximity relative to one another: same device, same server rack, same data center, same cloud region, or some other degree of proximity. As used herein, an anti-affinity requirement refers to a requirement that two components have a required degree of separation from one another: different devices, different server racks, different data centers, different cloud regions, or some other degree of distance.

The orchestrator 106 may invoke 406 instantiation of a new NFS server pod 112c on the selected host. For example, the orchestrator 106 may invoke performance of a workflow for instantiating the new NFS server pod 112c on the selected host. The orchestrator 106 may invoke instantiation 406 of the new NFS server pod 112c on the selected host by generating a pod specification 300 for a pod including a container executing an NFS server. The pod specification 300 may include an annotation that is interpreted by the orchestrator agent 306. For example, the annotation may include the IP address to assign to the new NFS server pod 112c or an instruction to obtain the IP address from the orchestrator 106 when instantiating a container hosting the NFS server. Instantiation of the new NFS server pod 112c may be performed by a KUBERNETES master of the cluster 111 in which the new NFS server pod 112c is to be instantiated. Instantiation of the new NFS server pod 112c may include instantiation of a Kubelet 302 implementing the new NFS server pod 112c.

The Kubelet 302 may invoke 408 instantiation of a container 114d and NFS server 118d in the new NFS server pod 112c by the CRI referenced by the CRI identifier 304, which is the orchestrator agent 306. The orchestrator agent 306 may then instantiate 410 the container 114d and NFS server 118d on the selected host, such as according to a pod specification 300 received from the orchestrator 106 or a separate container specification.

The orchestrator agent 306 may obtain 412 NFS server configuration data from the orchestrator 106 and configure 414 the new NFS server pod 112c according to the configuration data. The configuration data may include such information as an identifier of one or more storage volumes 116b to be mounted to the new NFS server pod 112c, an IP address of the NFS service 200, an IP address assigned to the new NFS server 118d and/or container 114d, an identifier of the new NFS server 118d, and/or authentication data for authenticating requests for data from the new NFS server 118d or for authenticating the new NFS server 118d with respect to the NFS service 200. The orchestrator agent 306 may obtain 412 the NFS server configuration data by requesting the data from the orchestrator 106 and receiving the data in response. The orchestrator agent 306 may also obtain the NFS server configuration data in an annotation to the pod specification 300 that is passed by the Kubelet 302 to the orchestrator agent 306.

Configuring 414 the new NFS server pod 112c may include configuring the container 114d and/or NFS server 118d to communicate using the IP addresses provided in the NFS server configuration data, to authenticate using the authentication data provided in the NFS server configuration, or otherwise configure the new NFS server pod 112c according to the NFS server configuration data.

The storage volume 116b may be mounted 416 to the container 114d following, or as part of, instantiation of the container 114d. In order to avoid disruption, the storage volume 116b may be quiesced prior to mounting of the storage volume 116b to the new container 114d. For example, further read and write requests to the storage volume 116b may be momentarily suppressed to avoid missing read and/or write requests and then resumed once the storage volume 116b is mounted to the new container 114d and the new NFS server 118d has commenced functioning. Mounting 416 to the container 114d may further include unmounting the storage volume 116b from the container 114a to which the storage volume 116b was previously mounted.

In an alternative approach, the storage volume 116b may remain mounted to the original container 114a until the new container 114d commences functioning and the storage volume 116b is mounted to the container 114d, at which time the storage volume 116b may be unmounted from the original container 114a. Thus, disruption to usage of the storage volume 116b is minimal or non-existent.

After the storage volume 116b is mounted to the container 114d and the container 114d commences functioning, the orchestrator 106 may configure 418 the NFS service 418 such that requests to access the storage volume 116b will be sent to the new NFS server 118d. For example, the NFS service 200 may be configured to associate an identifier of the storage volume 116b with the IP address assigned to the NFS server 118d and/or container 114d. The NFS service 412 may be configured to authenticate the new NFS server 118d in response to authentication data provided at step 410. The new NFS server 118d may be configured to use the NFS service 200 as a proxy for read and write requests received from an application instance 118b.

Once the new NFS server 118d commences operating and the NFS service 200 is configured to use the new NFS server 118d for access to the storage volume 116b, the storage volume 116b may be unmounted from the container 114a in embodiments where a storage volume can be mounted to multiple containers 114a. The application instance 118b may thereafter perform file system access (e.g., file reads and writes, file system navigation, creating directories, deleting directories, etc.) with respect to the storage volume 116b by sending requests to the new NFS server 118d directly or by way of the

NFS service 200 acting as a proxy. The NFS service 200 may provide the association between the storage volume 116b and the new NFS server 118d to one or more application instances 118b, 118c or hosting pod 112b in order to enable access to the new NFS service 200.

The above-described ordering of events for the method 400 is exemplary only and the order may be selected for a given network environment so as to manage the transfer of the storage volume 116b to the new container 114d while reducing disruption to the application instances 118b that use the storage volume 116b.

FIG. 5 is a block diagram illustrating an example computing device 500. Computing device 500 may be used to perform various procedures, such as those discussed herein. The servers 102, orchestrator 106, workflow orchestrator 122, and cloud computing platform 104 may each be implemented using one or more computing devices 500. The orchestrator 106 and workflow orchestrator 122, may be implemented on different computing devices 500 or a single computing device 500 may host one or both of the orchestrator 106 and workflow orchestrator 122.

Computing device 500 includes one or more processor(s) 502, one or more memory device(s) 504, one or more interface(s) 506, one or more mass storage device(s) 508, one or more Input/output (I/O) device(s) 510, and a display device 530 all of which are coupled to a bus 512. Processor(s) 502 include one or more processors or controllers that execute instructions stored in memory device(s) 504 and/or mass storage device(s) 508. Processor(s) 502 may also include various types of computer-readable media, such as cache memory.

Memory device(s) 504 include various computer-readable media, such as volatile memory (e.g., random access memory (RAM) 514) and/or nonvolatile memory (e.g., read-only memory (ROM) 516). Memory device(s) 504 may also include rewritable ROM, such as Flash memory.

Mass storage device(s) 508 include various computer readable media, such as magnetic tapes, magnetic disks, optical disks, solid-state memory (e.g., Flash memory), and so forth. As shown in FIG. 5, a particular mass storage device is a hard disk drive 524. Various drives may also be included in mass storage device(s) 508 to enable reading from and/or writing to the various computer readable media. Mass storage device(s) 508 include removable media 526 and/or non-removable media.

I/O device(s) 510 include various devices that allow data and/or other information to be input to or retrieved from computing device 500. Example I/O device(s) 510 include cursor control devices, keyboards, keypads, microphones, monitors or other display devices, speakers, printers, network interface cards, modems, lenses, CCDs or other image capture devices, and the like.

Display device 530 includes any type of device capable of displaying information to one or more users of computing device 500. Examples of display device 530 include a monitor, display terminal, video projection device, and the like.

Interface(s) 506 include various interfaces that allow computing device 500 to interact with other systems, devices, or computing environments. Example interface(s) 506 include any number of different network interfaces 520, such as interfaces to local area networks (LANs), wide area networks (WANs), wireless networks, and the Internet. Other interface(s) include user interface 518 and peripheral device interface 522. The interface(s) 506 may also include one or more peripheral interfaces such as interfaces for printers, pointing devices (mice, track pad, etc.), keyboards, and the like.

Bus 512 allows processor(s) 502, memory device(s) 504, interface(s) 506, mass storage device(s) 508, I/O device(s) 510, and display device 530 to communicate with one another, as well as other devices or components coupled to bus 512. Bus 512 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 500, and are executed by processor(s) 502. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

In the above disclosure, reference has been made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Claims:

1. An apparatus comprising:
a computer system including a plurality of processing devices and one or more memory devices operably coupled to the plurality of processing devices, the one or more memory devices storing executable code that, when executed by the plurality of processing devices, causes the plurality of processing devices to:
execute a cluster including a first pod implementing a first remote file system server, the first pod having a plurality of storage volumes mounted thereto;
execute, in the cluster, a remote file system service for enabling access to the first remote file system server;
execute, in the cluster, a plurality of application instances configured to access the plurality of storage volumes using the first remote file system server using the remote file system service;
instantiate, in the cluster, a second pod implementing a second remote file system server;
mount at least one storage volume of the plurality of storage volumes to the second remote file system server; and
configure the remote file system service to enable access to the at least one storage volume using the second remote file system server.

2. The apparatus of claim 1, wherein the first and second remote file servers are network file system (NFS) servers.

3. The apparatus of claim 1, wherein the executable code, when executed by the plurality of processing devices, further causes the plurality of processing devices to:
call a container runtime interface to instantiate the second remote file system server and a container executing the second remote file system server.

4. The apparatus of claim 3, wherein the executable code, when executed by the plurality of processing devices, further causes the plurality of processing devices to:
receive, by the container runtime interface, configuration data from an orchestrator; and
configure the first remote file system server and the container according to the configuration data.

5. The apparatus of claim 4, wherein the configuration data includes an address for the first remote file system server.

6. The apparatus of claim 4, wherein the configuration data includes an address for the remote file system service.

7. The apparatus of claim 4, wherein the container runtime interface is an agent of the orchestrator.

8. The apparatus of claim 1, wherein the remote file system service is a construct within an internal network of the cluster.

9. The apparatus of claim 1, wherein the cluster is a KUBERNETES cluster.

10. The apparatus of claim 1, wherein the computer system comprises a first host and a second host, the first remote file system server executing on the first host and the second remote file system server executing on the second host.

11. A method comprising:
executing, by a computer system comprising a plurality of hosts, a cluster including a first pod implementing a first remote file system server, the first pod having a plurality of storage volumes mounted thereto;
executing, by the computer system, in the cluster, a remote file system service for enabling access to the first remote file system server;
executing, by the computer system, in the cluster, a plurality of application instances configured to access the plurality of storage volumes using the first remote file system server using the remote file system service;
instantiating, by the computer system, a second pod implementing a second remote file system server;
mounting, by the computer system, at least one storage volume of the plurality of storage volumes to the second remote file system server; and
configuring, by the computer system, the remote file system service to enable access to the at least one storage volume using the second remote file system server.

12. The method of claim 11, wherein the first and second remote file servers are network file system (NFS) servers.

13. The method of claim 11, further comprising calling, by the computer system, a container runtime interface to instantiate the second remote file system server and a container executing the second remote file system server, the at least one storage volume being mounted to the container.

14. The method of claim 13, further comprising:
receiving, by the container runtime interface, configuration data from an orchestrator; and
configuring, by the container runtime interface, the first remote file system server and the container according to the configuration data.

15. The method of claim 14, wherein the configuration data includes an address for the first remote file system server.

16. The method of claim 14, wherein the configuration data includes an address for the remote file system service.

17. The method of claim 14, wherein the container runtime interface is an agent of the orchestrator.

18. The method of claim 11, wherein the remote file system service is a construct within an internal network of the cluster.

19. The method of claim 11, wherein the cluster is a KUBERNETES cluster.

20. The method of claim 11, wherein the computer system comprises a first host and a second host, the first remote file system server executing on the first host and the second remote file system server executing on the second host.
